(19) United States
(12) Patent Application Publication
(10) Pub. No.: US 2012/0228311 A1
(43) Pub. Date: Sep. 13, 2012

(54) DISPOSABLE CASK WITH DISPOSABLE TAP

(76) Inventors: Hans Peter Sauer, Muelheim-Kaerlich (DE); Werner Neukirch, Andernach (DE)

(21) Appl. No.: 13/498,416

(22) PCT Filed: Sep. 24, 2010
(86) PCT No.: PCT/EP2010/064186

§ 371 Date: May 29, 2012

(30) Foreign Application Priority Data
Sep. 28, 2009 (DE) 20 2009 013 016.9
Oct. 21, 2009 (DE) 20 2009 014 229.9

(51) Int. Cl. B67D 1/04; B65D 47/20

(52) U.S. Cl. 220/592.19; 220/661

(57) ABSTRACT

The invention relates to a single use cask for pressurised liquid, particularly beverages, with a cask bottom, a cask side wall and a cask lid, wherein a stand is formed on the cask bottom, and the cask side wall has an opening in which a single use tap is arranged, wherein the single use cask, by virtue of its height within a range of between 100 mm and 200 mm, preferably of between 125 mm and 175 mm, and particularly preferably of 160 mm, can be positioned upright in a conventional domestic fridge.

The invention relates to a single use cask for pressurised liquid, in particular beer, comprising a cask bottom, cask side wall and cask lid, which form a storage receptacle for liquid having a storage volume of at least 2.5 litres. Single use casks of this type are known from the prior art in the form of 5 litre and 10 litre party casks. These correspond to conventional drink and beer casks in their external appearance, but consist of metal, such as tinplate or aluminium. The cask bottom, cask lid and cask side wall are connected to one another at their edge regions in a fluid-tight and pressure-tight manner, for example by means of flanges or the like. A base is formed at the bottom of the cask. An opening is provided in the cask side wall, in which opening a tap is to be arranged or is arranged.

For visual and aesthetic reasons, inter alia, the dimensions of the single use casks known from the prior art are adapted to the dimensions of traditional wood or plastics material beer casks which are intended for multiple use. A conventional five litre single use cask has, in the case of a height of approximately 250 mm, a diameter of approximately 160 mm, and correspondingly, a conventional 10 litre single use cask has, in the case of an overall height of approximately 325 mm, a diameter of approximately 200 mm. The height/width ratio of conventional single use casks is thus approximately H/W=1.6. Known single use casks are provided with a tap, which is disposed of together with the container after said container has been emptied. Using these casks, an end user can tap beer in the conventional manner and simultaneously enjoy the advantages of single use casks.

It is disadvantageous that known single use casks, in the same way as traditional beer casks, must be pre-cooled in correspondingly large refrigerators owing to their dimensions, in order that the drink can be tapped from the cask at the temperature provided for consumption, 4 to 8° C. in the case of beer. Owing to the good thermal insulation properties of wood and plastics material, a traditional wood or plastics material cask pre-cooled to the consumption temperature can also maintain the consumption temperature for longer after cooling has ended, for example in the case of transport or a lengthy tapping process. However, owing to the poor thermal insulation properties of metals when they are used for single use casks, the liquid accommodated in the single use cask warms up more quickly than in traditional casks when cooling is discontinued, which impairs the enjoyment of the drink. This is in particular disadvantageous in the case of a lengthier tapping of drink. Single use casks are generally intended for use by an occasional end user and, in the context of a drink tapping arrangement, are set up at room temperature in such a way that the drink warms up relatively quickly. A post-cooling during the use of the cask is expensive and impractical and not feasible for the majority of users.

For the consumers of the single use casks, it is generally only possible to cool the casks in a conventional household refrigerator or similar. Owing to the above-mentioned dimensions thereof, known single use casks can only be placed into conventional household refrigerators in a horizontal position. It is not possible to tap the drink in this position. In this manner, the drink can be cooled to consumption temperature up until shortly before the cask is opened, but the drawback of a relatively quick warming of the drink after the cask has been opened still exists. In order to store a known single use cask upright in a household refrigerator, in such a way that the drink could be tapped, the refrigerator would have to be arranged to accommodate the upright single use cask by removing partitions, as a result of which it would no longer be capable, or only capable to a restricted degree, of cooling other food and drink.

Starting from the above-described prior art, the object of the invention is to provide a single use cask for pressurised liquids, in particular drinks and drinks containing carbon dioxide, which cask incorporates the advantages of known single use casks, can be easily cooled by the end user in a conventional household refrigerator to the consumption temperature required in each case and maintained thereat, the storage capacity of the household refrigerator being restricted as little as possible and alterations thereto not being required, and finally the tapping of drink from the single use cask being able to take place without it having to be removed from the household refrigerator intended for the cooling.

This object is achieved by a single use cask for pressurised liquid, in particular beer, having a cask bottom, a cask side wall and a cask lid, which form a storage receptacle for the liquid having a storage volume of at least 2.5 litres, a base being formed by the cask bottom and the cask side walls comprising an opening, in which a single use tap is arranged, the single use cask having a maximum height, starting from the base, in a range between 100 mm and 200 mm, preferably between 125 mm and 175 mm and particularly preferably of 160 mm.

A single use cask with height dimensions such as these can advantageously be placed into a conventional household refrigerator, upright on its base. In this case, the single use cask can be arranged upright in the refrigerator shelves, generally without partitions having to be removed or rearranged. The single use tap arranged in the opening of the cask side wall is freely accessible for the end user when the single use cask is in the upright position and can be brought out of the first operating position into its second operating position and vice versa and can, in particular in the second operating position, be used for tapping drink. In this way, the tapping process can take place without the single use cask having to be removed from the refrigerator. This makes it possible, particularly advantageously, for an end user to easily pre-cool the drink contained in the single use cask by arranging the single use cask in a household refrigerator and also for the barrel not to have to be removed therefrom during use, that is to say during a plurality of tapping processes which are temporally spaced from one another, and a continuous cooling of the drink is thereby provided. The drink can thus be particularly easily maintained at the desired consumption temperature until the single use cask has been completely emptied.

A further advantageous technical effect is that the single use cask according to the invention has a lower side wall height than with single use casks of the prior art. The height/width ratio is increased in comparison with single use casks of the prior art and is approximately 1/1. This already provides an improved footing stability in comparison with higher casks. Due to the reduced side wall height, the single use cask according to the invention also has an improved stability in relation to bulges and buckles as types of mechanical fault, as a result of which an improved loading capacity is achieved in the case of forces acting perpendicular to the cask bottom and lid (such as occur in the case of stacks of single use casks), which in turn leads to an improved stackability.

According to a particular embodiment of the invention, the cask bottom and the cask lid are circular and the cask side wall is radially symmetrical. As a result, only the cask side wall of a single use cask according to the invention has to be produced differently from the prior art. Cask lids and bottoms can be used in an identical shape and size. As a result, production methods and devices for single use casks of the prior art can in turn be used particularly advantageously. This relates in particular to machines and systems for producing bottoms and lids, and to the joining of these to the cask side wall. In the case of the cask bottom and lid having the same diameter and a cask height reduced to 150 to 160 mm, a storage volume of approximately 3 to approximately 3.1 l is produced. In order to produce single use casks having larger volumes, larger cask bottoms and lids can be used in the case of the same height. In this way, a 5 litre single use cask is for example produced having a height of 160 mm and a diameter of approximately 200 mm.

In a further embodiment, the single use cask comprises a retractable single use tap. The retractable single use tap has a first operating position, in which it closes substantially flush with or retracted into the cask side wall. The single use tap cannot be used for tapping drink in this operating position, but must firstly be brought into a second operating position, in which it projects out from the cask side wall. Once it is in this second position, a user can use the tap to tap the drink. In its first operating position, the tap does not project significantly over the side wall of the cask, in such a way that the cask can be handled and stacked during filling and transportation without the danger of the tap being damaged.

In principle, the single use tap can be arranged in the side wall either in the region of the bottom of the cask or in the region of the lid of the cask. The second case is particularly preferable since it is then particularly easy to tap, without having to position the single use cask near to an edge in order to be able to arrange a glass under the tap. In the second case, the tap is connected to a feed pipe inside the cask in such a way that it is possible to tap the drink until the cask is almost completely empty. The cask is under excess pressure in order to allow tapping of drink using the tap which is located above the liquid level after the cask has been partially emptied. The pressurisation preferably takes place via an internal pressure system, which comprises a pressure reducing valve and a regulating valve and is arranged inside the cask. It is particularly advantageous to use an internal pressure system of the type disclosed in EP 1 688 814 B1. The disclosures of EP 1 688 814 B1 are referred to in this instance in their entirety.

The single use tap can in principle be produced from any material, but it preferably consists substantially of plastics material and more particularly preferably of a combination of more rigid and more flexible plastics material parts. It is produced completely as a single use element and then inserted in a sealing manner into the opening of the single use cask, which is still empty, provided for the tap. The tap preferably comprises an external casing, which accommodates a pipe arranged in the inner channel thereof in a sealing and movable manner. The pipe has a handle element which is accessible to the end consumer and an outlet opening for the drink. The pipe also comprises inlet openings which, in the first operating position of the tap, are covered and sealed by the external case. In the second operating position, the inlet openings are connected to the orifices arranged in the external case. The interior of the cask can then be connected to the surroundings via the orifices, the inlet openings and the inner channel of the inner pipe. The connection is sealed by means of a conventional stop valve, which can be used by the end consumer to tap the drink.

The tap preferably has a catch mechanism on the outer casing thereof, using which mechanism the tap can be arranged in the side wall opening of the single use cask in such a way that it cannot be detached by the end consumer. For example, the outer casing can bear two peripheral flanges or catch wedge rings, between which a sealing ring is located. When the outer casing is locked in the opening of the cask provided therefor, the edges of this opening are positioned on the seal and are held by the flanges or the catch wedge rings.

The closed position (first operating position), in which the sliding pipe is inserted so far into the casing that the casing completely covers the outlet opening or closes the inner pipe substantially flush with the cask side wall, is generally identical to the state of the sliding pipe in which it is completely pushed into the outer casing. In order to prevent the sliding pipe from being able to be pushed out beyond a desired position, in which the outlet opening projects out of the outer casing, a stop can be produced in any manner, for example by providing a slide hole or slide opening in the outer casing, which hole or opening can cooperate with a slide block or the like which is mounted on the outside of the lower region of the sliding pipe. A configuration of this type is, for example, disclosed in DE 198 35 596 A1, in which a pipe-shaped slide block is used. Alternatively, a trough-shaped recess can be provided, which serves to guide a corresponding stop lug.

The stop valve can be arranged in any position inside the sliding pipe. It is preferably arranged in the central region of the inner wall of the sliding pipe and comprises, as disclosed in DE 198 35 569 for example, a valve seat, which is formed by an annular collar on the inside of the sliding pipe and forms a conical seat surface, which is sealed using a conical valve face. This is connected in turn to a valve lifter or formed integrally therewith, the valve lifter being able to be provided with annular beads or grooves, which can cooperate with corresponding structures of a spout. The spout is resilient and can be integrally connected to a bellows which is also made of resilient material such as rubber and can be pushed in from the outside. If the rubber bellows is pressed down, the valve face is moved away from the valve seat against the pressure of the liquid present and against the restoring force, which come from the engagement of the resilient spout with the annular structures at the upper end of the inner region. Liquid can thus enter the outer region from the inner region and be tapped by the outlet opening. If the rubber bellows is released, the valve returns to its closed output position.

The sliding pipe preferably has openings or through-holes on its inner end face, via which openings or through-holes the liquid to be tapped can enter the inside of the pipe. This should however only be possible if the liquid container is being used and the tapping has begun. It is therefore necessary to prevent the liquid from entering the sliding pipe before the start of the first tapping process. This succeeds in that the inlet openings into the sliding pipe are covered in a sealing manner by a protective casing, which optionally covers, in a sealing manner, the slide opening or an opening provided for other reasons in the outer casing or the inner sliding pipe, or by the outer casing.

If the sliding pipe is moved into the second operating position using its handle, in which position the outlet opening on the outside of the liquid container projects out from the outer casing, the inlet openings in the inner pipe are unblocked and the liquid can enter the inner pipe, and specifically up to the height of the stop valve. The tapping process then takes place exclusively via the operation of the valve, without the inner pipe having to be displaced towards the outer casing.

In a particularly preferred configuration, the retractable tap consists of seven or eight parts, in particular a resilient cap, which is formed integrally with said spout, a valve lifter having an extension, which cooperates with the spout in the manner described, a valve face, which is slid onto the valve lifter and can be locked into this lifter, the sliding pipe having a handle and optionally a hole for the stop mechanism, for example the above-mentioned slide hole that is referred to, the outer casing, an insertion part, which can be inserted into the inner pipe mouth of the sliding pipe, and the faucet, which comprises end face inlet openings for liquid and optionally components for the stop mechanism, such as a slide block, as well as a one- or two-piece protective casing.

The tap formed in the manner previously disclosed is protected against liquid entry before the first operation. It has means for sealing coupling of a fill pipe or fill hose, through which, in the case of excess pressure in the cask, liquid is then forced into the tap, even if the liquid level is located below the tap. It does not require any opening for remaining liquid. If the coupling means for the fill pipe is laterally attached and can thus point downwards when fitted, the tap can be used in combination with any pressurisation systems, even if these systems, for example in the centre of the cover or the inner top side of the cask, extend downwards further than the height at which the tap is attached.

Further features and characteristics emerge from the following description of the invention on the basis of the figure, which shows the single use container in an exemplary embodiment.

The single use cask 1 shown in the figure comprises a cask bottom 2, a cask lid 3 and a cask side wall 4. The cask bottom 2 and cask lid 3 correspond to those of single use containers according to the prior art.

The cask bottom 2 is connected to the cask side wall 4 by means of a flanging 5. In the region of this flanging 5, a circumferential annular base 6 is formed. The inner region of the cask bottom 2 is formed set back towards the inside of the single use cask 1 in relation to the base 6. An annular groove 7 is formed adjacent to the base 6 in the outer region of the cask bottom 2. In the embodiment shown, the external diameter of the base is 165 mm and the internal diameter thereof is 160 mm.

The cask lid 3 is connected in a similar manner to a cask side wall 4 by means of a flanging 8. The inside of the cask lid 3 is also formed projecting towards the interior of the single use cask 1 with an annular circumferential groove 9 adjacent to the flanging 8. The external diameter of the cask lid 3 at the flanging 8 is approximately 157 mm, while the internal diameter of the flanging is approximately 153 mm. Owing to these dimensions, the single use cask 1 can be easily stacked on other single use casks, since the circumferential edge of the cask lid 3 engages the annular groove 7 of the cask bottom 2. In this way, single use casks 1 stacked on one another cannot be displaced in relation to one another and can be stacked in a particularly stable manner.

A central filling hole 10 is inserted in the cask lid 3, which hole can be closed by means of a ventilation plug (not shown in the figure) after the single use cask 1 has been filled.

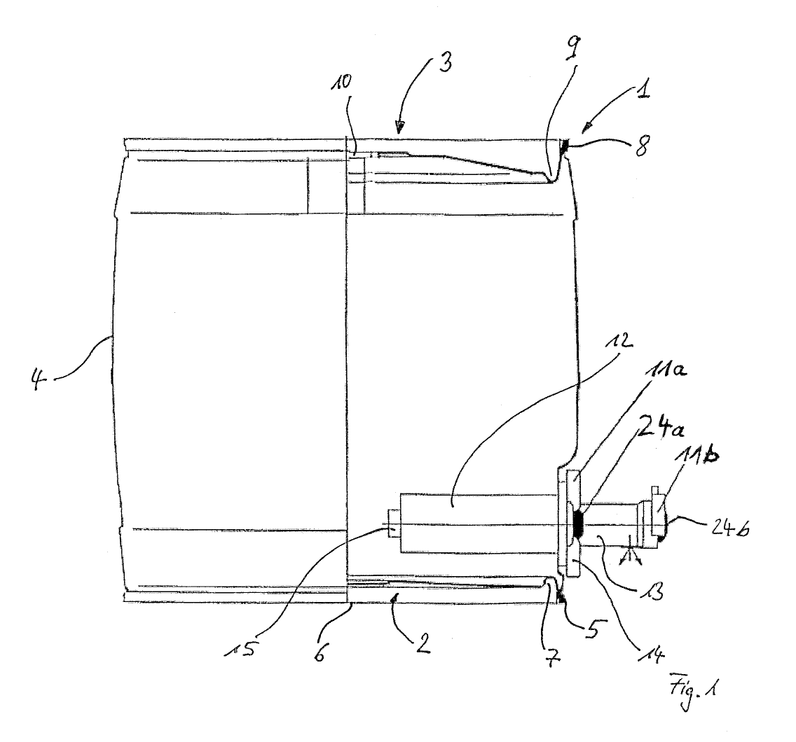

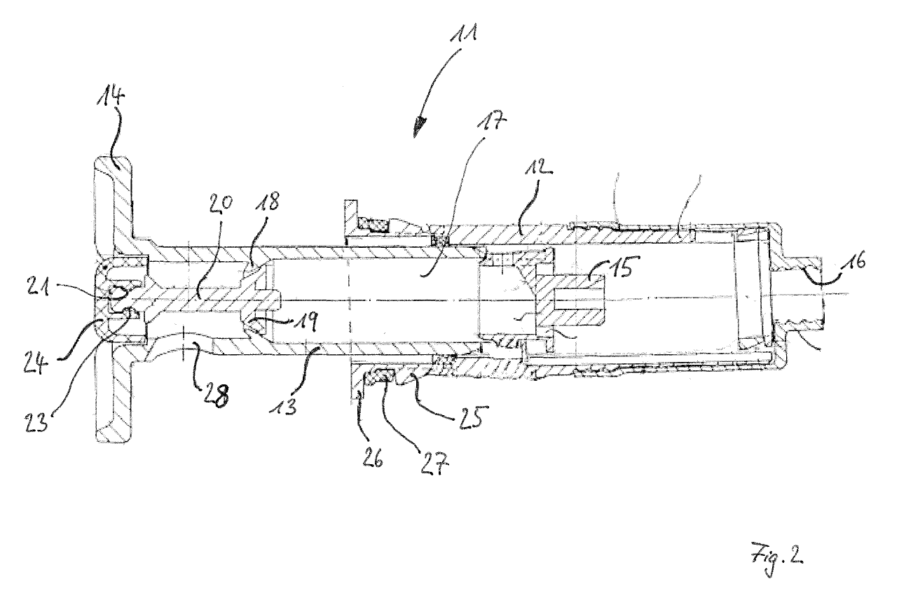

A single use tap 11 is arranged in the cask side wall 4, in the region of the cask bottom. The single use tap 11 penetrates the cask side wall 4 in a side opening (not visible in the figure) and consists substantially of an outer housing 12 (or casing) fixed in this opening, and an inner housing 13 (or inner pipe) axially displaceable in the outer housing 12. In the figure, the tap is shown in the two operating positions thereof, that is to say in one case with the inner housing 12 retracted into the outer housing 12, and in once case with the inner housing 13 extended out from the outer housing 12. The single use tap 11 is provided and assembled with the inner housing 13 retracted into the outer housing 12. If the single use tap 11 is to be used, the inner housing 13 should be pulled out from the outer housing 12, using a handle 14, into the extended position shown in the figure. In this case, a tap 15 visible in FIG. 2 extends out of a clearance 16, as a result of which a liquid connection between the storage reservoir of the single use cask 1 and an interior 17 of the inner housing 13 is produced. A valve arrangement is provided in the inner housing 13. A valve seat 18 formed in the inner housing 13 cooperates with a conical valve face 19. This valve face can be actuated via a valve lifter 20 which has an annular recess 21 in its upper end, which recess an annular bulge 23 of a rubber bellows 24 engages. In FIG. 2, detents 25 and a collar 26 are also visible, which serve as stopping means for stopping the single use tap 11 in the opening of the cask side wall 4. A sealing means 27 is provided for sealing, which means can consist, for example, of a flexible plastics material. On the outside of the valve seat 18, an outlet opening 28 is arranged for the drink tapped from the single use cask 1.

When the inner housing 13 is retracted into the outer housing 12, the faucet 15 of the inner housing 13 sits in a sealing manner in the opening 16 of the outer housing 12. This prevents entry of the fluid contained in the single use cask 1 into the interior 17 of the inner housing 13 and contact of the outlet valve with fluid. Furthermore, the outlet opening 28 is also located inside the outer housing 12, as a result of which soiling of the single use tap 11 from outside can be effectively prevented. When retracted, the tap 11 is preferably provided with an originality sealing (not shown in the figure).

### LIST OF REFERENCE NUMERALS

1 single use container
2 cask bottom
3 cask lid
4 cask side wall
5 flanging
6 base
7 groove
8 flanging
9 groove
10 filling hole
11a single use tap (retracted)
11b single use tap (extended)
12 outer housing
13 inner housing
14 handle
15 faucet
16 opening
17 interior (of 13)
18 valve seat
19 valve face
20 valve lifter
21 recess
23 bulge
24a rubber bellows (when single use tap is retracted)
24b rubber bellows (when single use tap is extended)
25 detent
26 collar
27 sealing means
28 outlet opening

1. A single use cask for pressurised liquid, comprising:
a cask bottom;
a cask side wall comprising an opening in which a single use tap is arranged;
a cask lid, wherein the cask bottom, the cask side wall, and the cask lid form a storage receptacle for the pressurized liquid having a storage volume of at least 2.5 litres; and
a base formed at the cask bottom;
characterised in that the single use cask has a maximum height, starting from the base, in a range between 100 mm and 200 mm.

2. The single use cask according to claim 1, characterised in that the cask has a storage volume of between about 3 litres and about 3.1 litres.

3. The single use cask according to claim 1, characterised in that the single use tap has a first operating position in which the single use tap closes substantially flush with or is retracted into the cask side wall, and a second operating position in which the single use tap projects out from the cask side wall.

4. The single use cask according to claim 1, characterised in that the single use tap and the opening in which it is accommodated are arranged in the cask side wall in proximity to the cask bottom.

5. The single use cask according to claim 1, characterised in that the single use tap and the opening in which it is accommodated are arranged in the cask side wall in proximity to the cask lid.

6. The single use cask according to claim 1, characterised in that a riser tube is arranged inside the single use cask, the riser tube being fluidly connected to the single use tap.

7. The single use cask according to claim 1, characterised in that the single use cask comprises a pressure reducing and regulating valve for adjusting the internal pressure prevailing in the single use cask.

8. The single use cask according to claim 1, characterised in that the cask bottom, the cask lid, and the cask side wall are formed substantially of metal.

9. The single use cask according to claim 1, characterised in that the single use cask has a maximum height, starting from the base, in a range between 125 mm and 175 mm.

10. The single use cask according to claim 1, characterised in that the single use cask has a maximum height, starting from the base, of about 160 mm.

11. The single use cask according to claim 1, characterised in that the cask bottom, the cask lid, and the cask side wall are formed substantially of tinplate or aluminium plate.
